(19) United States
(12) Patent Application Publication
(10) Pub. No.: US 2020/0382676 A1
(43) Pub. Date: Dec. 3, 2020

(54) COMMUNICATION APPARATUS, METHOD OF CONTROLLING COMMUNICATION APPARATUS, AND RECORDING MEDIUM

(71) Applicant: SHARP KABUSHIKI KAISHA, Osaka (JP)

(72) Inventors: TAKESHI YAMAGUCHI, Osaka (JP); YUICHI NISHII, Osaka (JP)

(21) Appl. No.: 16/883,429

(22) Filed: May 26, 2020

(30) Foreign Application Priority Data
May 30, 2019 (JP) 2019-101315

(51) Int. Cl. H04N 1/32; H04N 1/00

(52) U.S. Cl. CPC H04N 1/32096; H04N 1/32101; H04N 1/0048

(57) ABSTRACT

A communication apparatus includes an operation device that receives an operation of inputting information, designating a destination, and inputting a transmission setting, a transmitter that transmits information received via the operation device to a designated destination, a transmission setting device that receives a transmission setting via the operation device, a display that displays a predetermined setting screen and a message, and a controller that controls the above components. If the transmission setting device received a first transmission setting, the controller determines, if a second transmission setting is received from the operation device, whether the settings are settable simultaneously, and if the controller determines that the settings are not settable simultaneously, after controlling the display to display an occurrence of the error, the controller controls the display to display a setting screen related to a cancellation of the error, without returning to a screen before the occurrence of the error.

### BACKGROUND OF THE INVENTION

### Field of the Invention

The present invention relates to a communication apparatus, a method of controlling a communication apparatus, and a non-transitory computer-readable recording medium.

### Description of the Background Art

Information communication apparatuses represented by facsimile apparatuses or electronic mail devices may have a combination of functions of which a combined setting is not possible, such as a combined setting of “direct transmission” and “group destination”, among a plurality of settable functions.

If a combined setting is not possible, it is necessary to notify a user that the combined setting is not possible so that the user can properly change the setting.

In an example of such a conventional device, an image forming apparatus is disclosed in which if a plurality of functions not settable in combination are set, the image forming apparatus displays a function list screen in which a function triggering the impossible combined setting, and an already set function are marked (see, for example, Japanese Unexamined Patent Application Publication No. 2000-276010).

However, it is necessary to display the function list screen, and thus, in a device with limited screen display size, the conventional technology cannot be applied if a plurality of functions not settable in combination are set.

The present invention has been made in view of the above circumstances, and an object thereof is to provide a communication apparatus capable of easily identifying a cause of an error and resolving the error by a procedure easier than that in conventional devices, a method of controlling a communication apparatus therefor, and a non-transitory computer-readable recording medium therefor.

### SUMMARY OF THE INVENTION

1. The present invention provides a communication apparatus including an operation device that receives an operation of inputting information, designating a destination, and inputting a setting for transmission, a transmitter that transmits information received via the operation device to a designated destination, a transmission setting device that receives a setting for transmission via the operation device, a display that displays a predetermined setting screen and a message, and a controller that controls the operation device, the transmitter, the transmission setting device, and the display, in which if the transmission setting device has already received a setting for a first transmission, the controller determines, if a setting for a second transmission is received by the operation device, whether the setting for the second transmission is settable at the same time as the setting for the first transmission, and if the controller determines that the setting for the second transmission is not settable at the same time as the setting for the first transmission, after controlling the display to display an occurrence of the error, the controller controls the display to display a setting screen related to a cancellation of the error, without returning to a screen before the occurrence of the error.

Further, the present invention provides a method of controlling a communication apparatus including inputting information and a setting for transmission and designating a destination, receiving a setting for transmission in the inputting and the designating, displaying a predetermined setting screen and a message, and transmitting information input in the inputting and the designating, in which if a setting for a first transmission has already been received in the receiving, it is determined, if a setting for a second transmission is input in the inputting and the designating, whether the setting for the second transmission is settable at the same time as the setting for the first transmission, and if it is determined that the setting for the second transmission is not settable at the same time as the setting for the first transmission, in the displaying, after displaying an occurrence of the error, a setting screen related to a cancellation of the error is displayed, without returning to a screen before the occurrence of the error.

Further, the present invention provides a non-transitory computer-readable recording medium for recording a communication program causing a processor of a communication apparatus to execute inputting information and a setting for transmission and designating a destination, receiving a setting for transmission in the inputting and the designating, displaying a predetermined setting screen and a message, and transmitting information input in the inputting and the designating to a designated destination, in which if a setting for a first transmission has already been received in the receiving, it is determined, if a setting for a second transmission is input in the inputting and the designating, whether the setting for the second transmission is settable at the same time as the setting for the first transmission, and if it is determined that the setting for the second transmission is not settable at the same time as the setting for the first transmission, in the displaying, after displaying an occurrence of the error, a setting screen related to a cancellation of the error is displayed, without returning to a screen before the occurrence of the error.

In the present invention, a “communication apparatus” is a device having a function of transmitting character data or image data to a predetermined destination via a network.

Examples of the communication apparatus include a facsimile apparatus, and a personal computer (PC) having an electronic mail transmission function or a data transmission function.

The “display” in the present invention is implemented by a display panel 80. Further, the “transmitter” in the present invention is implemented by the cooperation of a line controller 60 and a modem 62.

According to the present invention, it is possible to realize a communication apparatus, a method of controlling a communication apparatus therefor, and a non-transitory computer-readable recording medium therefor by which it is possible to easily identify a cause of the error and to resolve the error by a procedure easier than that in conventional devices because if two transmission settings not settable at the same time are performed, after displaying an occurrence of the error, a setting screen related to a cancellation of the error is displayed, without returning to a screen before the occurrence of the error.

Further, preferable aspects of the present invention will be described.

2. The controller may display a setting screen corresponding to a setting for the second transmission as the setting screen related to the cancellation of the error.

Thus, it is possible to realize a communication apparatus capable of easily identifying a cause of the error and resolving the error by a procedure easier than that in conventional devices because a setting screen corresponding to the setting for the second transmission is displayed as the setting screen related to the cancellation of the error.

3. The controller may receive a cancellation setting of the error on the setting screen for the cancellation of the error.

Thus, it is possible to realize a communication apparatus capable of easily identifying a cause of the error and resolving the error by a procedure easier than that in conventional devices because the cancellation setting of the error is received on the setting screen related to the cancellation of the error.

4. If determining that the setting for the second transmission is not settable at the same time as the setting for the first transmission, the controller may determine, in accordance with a predetermined determination criterion, whether the setting for the second transmission allows a user to imagine a content of an error, and if the controller determines that the setting for the second transmission does not allow the user to imagine the content of the error, after controlling the display to display an occurrence of the error, the controller may controls the display to display a setting screen related to a cancellation of the error.

Thus, it is possible to realize a communication apparatus capable of easily identifying a cause of the error and resolving the error by a procedure easier than that in conventional devices because if the controller determines that the setting for the second transmission does not allow the user to imagine the content of the error, after controlling the display to display an occurrence of the error, the controller controls the display to display a setting screen related to a cancellation of the error.

5. If a content input in the setting for the second transmission includes a telephone number, a facsimile (FAX) number, an email address, an internet protocol (IP) address, or a uniform resource locator (URL), the controller may determine that the setting for the second transmission does not allow a user to imagine a content of an error.

This is not limited to the “telephone number, FAX number, email address, IP address, and URL”, but an input content which the user is to set may be any combination of numbers, characters, and symbols from which the actual setting content cannot immediately be imagined.

Thus, it is possible to realize a communication apparatus capable of easily identifying a cause of the error and resolving the error by a procedure easier than that in conventional devices because if a content input in the setting for the second transmission includes a telephone number, a FAX number, an email address, an IP address, or a URL, it is determined that the setting for the second transmission does not allow a user to imagine a content of an error.

### BRIEF DESCRIPTION OF THE DRAWINGS

FIG. 1 is a configuration diagram of a communication system including facsimile apparatuses according to a first embodiment of the present invention;

FIG. 2 is a block diagram illustrating a schematic configuration of the facsimile apparatuses in FIG. 1;

FIG. 3 is an explanatory diagram illustrating an operation device in FIG. 2;

FIG. 4 is a sequence chart illustrating a facsimile communication procedure between a transmission-side facsimile apparatus and a reception-side facsimile apparatus in FIG. 1;

FIG. 5 is a flowchart illustrating an example of a screen transition process of the transmission-side facsimile apparatus in FIG. 1; and

FIG. 6 is a flowchart illustrating a screen transition process of a transmission-side facsimile apparatus according to a second embodiment of the present invention.

### DESCRIPTION OF THE PREFERRED EMBODIMENTS

The present invention will be described below in more detail with reference to the drawings.

It is noted that the following description is an exemplified illustration in all aspects and should not be interpreted to limit the present invention.

### First Embodiment

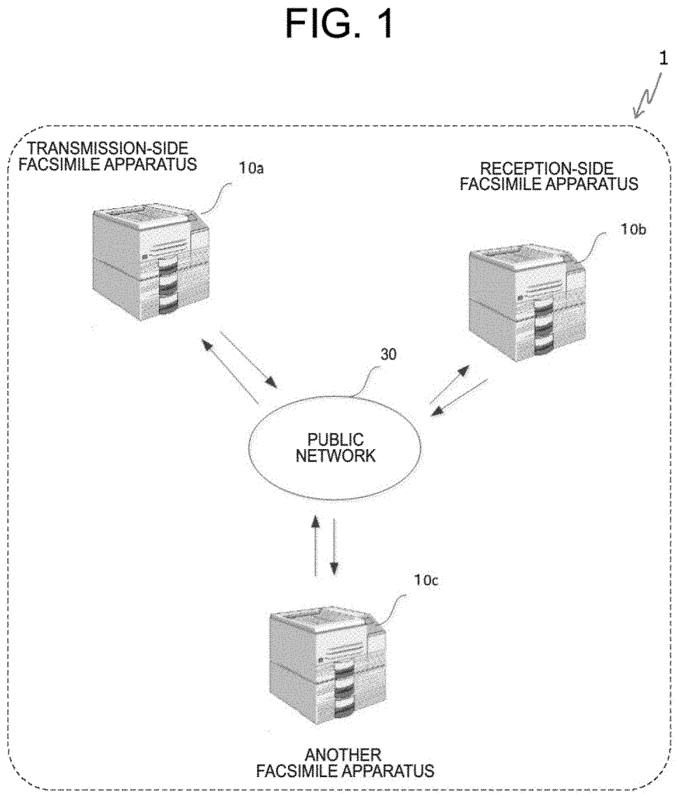

A communication system 1 including facsimile devices 10a to 10c, which are embodiments of a communication apparatus according to the present invention, will be described with reference to FIG. 1 to FIG. 3.

FIG. 1 is a configuration diagram of the communication system 1 including the facsimile apparatuses 10a to 10c according to a first embodiment of the present invention.

It is noted that the present invention is not limited to the communication system 1 including the facsimile apparatuses 10a to 10c, but is applicable to all systems having a communication function such as an electronic mail transmission function and a data transmission function.

The communication system 1 includes the facsimile apparatuses 10a, 10b, and 10c.

The facsimile apparatus 10a is a facsimile apparatus on a data transmission side (calling side).

The facsimile apparatus 10b is a facsimile apparatus on a data reception side (called side).

The facsimile apparatus 10c is a facsimile apparatus not related to this transmission and reception.

The facsimile apparatuses 10a, 10b, and 10c are connected to a public network 30 (general public telephone line) and transmit and receive facsimile image data.

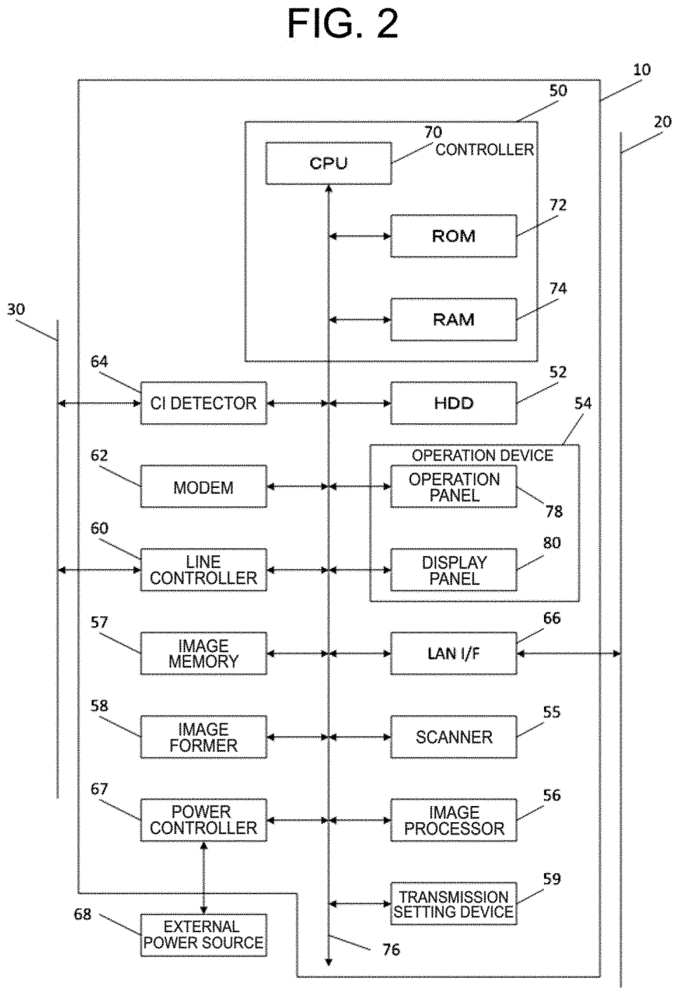

FIG. 2 is a block diagram illustrating a configuration of the facsimile apparatuses 10a to 10c according to the first embodiment.

It is noted that the facsimile apparatuses 10a, 10b, and 10c have a common configuration, and thus, will be described collectively as a facsimile apparatus 10 below.

A functional configuration of the facsimile apparatus 10 will be described with reference to FIG. 2.

The facsimile apparatus 10 includes a controller 50, a hard disk drive (HDD) 52, an operation device 54, a scanner 55, an image processor 56, an image memory 57 and an image former 58 included in a printer, a transmission setting device 59, the line controller 60, the modem 62, a calling indicator (CI) detector 64, a local area network (LAN) interface (LAN I/F) 66, and a power controller 67.

Each of the constituent components of the facsimile apparatus 10 will be described below.

The controller 50 is substantially a computer, and includes a central processing unit (CPU) 70, a read-only memory (ROM) 72, and a random-access memory (RAM) 74.

A BUS line 76 is connected to the CPU 70, and the ROM 72 and the RAM 74 are electrically connected to the BUS line 76.

The CPU 70 executes various types of computer programs in accordance with an instruction from the operation device 54 or the like, to execute a desired process such as an operation of each of the components of the facsimile apparatus 10.

The various types of computer programs are stored in the ROM 72 or the HDD 52 in advance, and are read from the ROM 72 or the HDD 52 and transferred to the RAM 74 during the execution of the desired process.

The CPU 70 reads and interprets a program instruction from an address in the RAM 74, designated by a value stored in a register called a program counter (not illustrated) in the CPU 70.

Further, the CPU 70 reads data necessary for an arithmetic operation from an address designated by the read instruction, and executes the arithmetic operation corresponding to the instruction for the data.

The result of the execution is also stored at the address designated by the instruction, such as a register in the RAM 74, the HDD 52, and the CPU 70.

Further, the HDD 52, the operation device 54, the scanner 55, the image processor 56, the image memory 57, the image former 58, the line controller 60, the modem 62, the continuous integration (CI) detector 64, the LAN interface (I/F) 66, and the power controller 67 are electrically connected to the BUS line 76.

The HDD 52 includes a magnetic recording medium, and stores image data and registration data registered at an installation location of the facsimile apparatus 10, such as a fax number and a mail address of a communication partner.

These registration data are registered when an administrator of the facsimile apparatus 10 or a user different from the administrator performs an input operation or the like on the operation device 54 to execute a plurality of functions included in the facsimile apparatus 10.

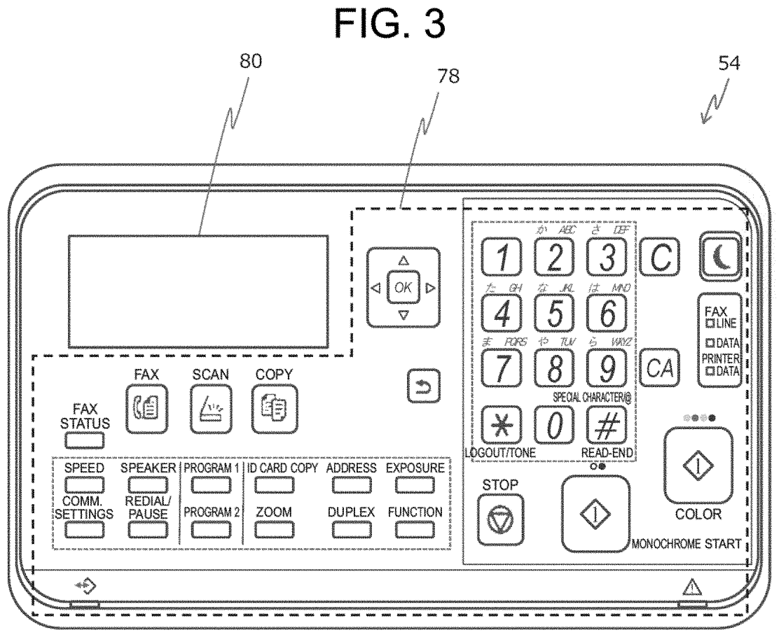

The operation device 54 includes an operation panel 78 including types of hard keys, as illustrated in FIG. 3.

The various types of hard keys include numeric keys for inputting a set value and the like such as a fax number of a communication partner or the number of copies, a power key for instructing to turn a power source on and off, a start key for instructing a start of various types of jobs, and a system setting key.

If the administrator depresses the system setting key, it is possible to utilize functions such as destination registration of a fax number, a mail address, and the like of a communication partner, an initial setting such as a time setting of a built-in clock, and initialization of the facsimile apparatus 10.

The operation device 54 further includes the display panel 80 configured by stacking a liquid crystal display (LCD) and a touch panel.

The display panel 80 provides a user with an interactive operation interface.

The operation device 54 receives an instruction from the user for the operation of the entire facsimile apparatus 10 through the various types of hard keys on the operation panel 78 or the touch panel of the display panel 80, displays a content of the instruction on the LCD of the display panel 80, and outputs a control signal in accordance with the instruction, to the controller 50 or a micro processing unit (MPU, not illustrated) of the image processor 56 or the like.

It is noted that the display panel 80 of the operation device 54 is often configured by an LCD and a touch panel, however, in the first embodiment, for simplicity, a system is exemplified in which the instruction is given by the hard keys on the operation panel 78.

However, the present invention is not limited thereto, and the instruction for the screen transition may be given by the touch panel.

The scanner 55 includes a document scanning device including a light source, a reflection mirror, an optical lens, and a charge-coupled device (CCD) line sensor (all of which are not illustrated).

In the document scanning device, light is emitted from the light source on an image surface of a document placed on a platen (not illustrated) manually by a user or by an auto document feeder (not illustrated) to obtain a reflected light image.

The reflection mirror and the optical lens form the obtained reflected light image on the CCD line sensor. The CCD line sensor sequentially photoelectrically converts the formed reflected light image into image data and outputs the image data to the image processor 56.

The image processor 56 includes the MPU (not illustrated).

The image processor 56 performs various types of processes including, for example, a predetermined image process such as a rasterization process on the image data received from the scanner 55, generates print data having a predetermined gradation, and outputs the print data to the image memory 57.

The image memory 57 includes a RAM, and temporarily stores the print data for each page.

The image memory 57 temporarily stores the print data input from the image processor 56 or print data transmitted from an external device for each page to transmit the print data to the image former 58 in accordance with an instruction from the controller 50 or the like, and outputs the stored print data to the image former 58 in synchronization with image formation by the image former 58.

The image former 58 includes a photosensitive drum, a charger, a Laser Scanning Unit (LSU), a developing device, a transfer device, a cleaning device, a fixing device (all of which are not illustrated), and a toner cartridge detachably mounted on the facsimile apparatus 10.

The image former 58 further includes a manual sheet feed tray, a first sheet feed tray, and a second sheet feed tray (all of which are not illustrated), which are detachably mounted on the facsimile apparatus 10.

These sheet feed trays are arranged vertically in this order, hold a recording sheet, and feed the recording sheet to a sheet conveyor (not illustrated).

The manual sheet feed tray is a tray on which a user manually places a desired recording sheet, and the first sheet feed tray and the second sheet feed tray are, for example, trays holding recording sheets having different size.

The image former 58 prints an image based on print data transmitted from the image memory 57 on a recording sheet conveyed from any of the above-described sheet feed trays via the sheet conveyor, in accordance with an instruction from the controller 50 or the like.

The transmission setting device 59 receives a setting for transmission, such as a setting of a transmission destination address.

The line controller 60 is a hardware circuit interfacing with the public network 30 being an analog line.

A plurality of external devices such as an external facsimile apparatus that performs facsimile communication with the facsimile apparatus 10 are connected to the public network 30.

The line controller 60 performs network control to control the closing and opening of the public network 30 and connects the modem 62 and the public network 30 as necessary, in accordance with an instruction from the controller 50.

The line controller 60 further transmits, to the communication partner, a dial signal in accordance with the fax number of the communication partner to call an external device of the communication partner connected to the public network 30.

The modem 62 includes a facsimile modem enabling facsimile communication, and is connected to the public network 30 via the line controller 60.

The modem 62 converts digital data to be transmitted to the communication partner into analog data, and transmits the analog data to the public network 30 via the line controller 60.

The modem 62 further converts analog data received from the communication partner via the line controller 60 into digital data and demodulates the data.

The demodulated image data is decoded by an encoder/decoder (not illustrated) and then output to the image memory 57.

The CI detector 64 detects a call signal (CI signal) from an external device connected to the public network 30 and notifies the controller 50 of the detection result.

If determining that the CI signal is detected for a predetermined time period, the controller 50 instructs the line controller 60 to close the public network 30 to capture the public network 30 through the modem 62.

If the public network 30 is captured, facsimile communication is performed by the modem 62.

The LAN I/F 66 interfaces with a network 20.

The facsimile apparatus 10 performs data communication with various types of external devices on the network 20 via the LAN I/F 66, according to a predetermined communication protocol.

The power controller 67 is electrically connected to an external power source 68.

The power controller 67 acquires power required for the operation of each of the components of the facsimile apparatus 10 from the external power source 68 and supplies the acquired power to each of the components of the facsimile apparatus 10.

The facsimile apparatus 10 operates each of the above-described components to execute, in accordance with an instruction from a user input operation through the operation device 54 or an instruction from an external device, any one mode among various types of modes such as a copy mode in which a document image is read and printed on a recording sheet, a printer mode in which print data transmitted from an external device is received and printed on a recording sheet, and a scanner mode in which a document image is read and transmitted to an external device.

Next, a communication procedure between the facsimile apparatuses 10a and 10b in FIG. 1 will be described.

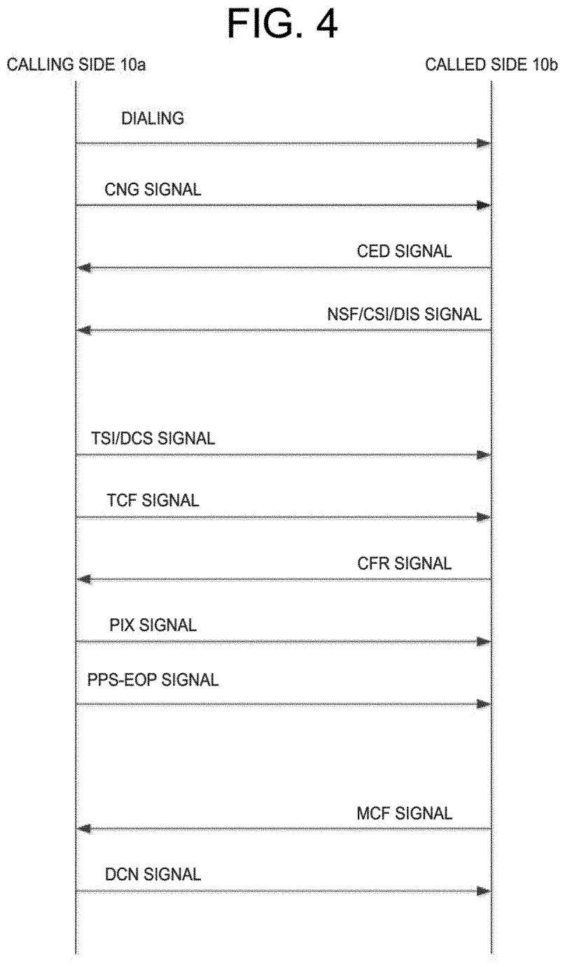

FIG. 4 is a sequence chart illustrating a facsimile communication procedure between the transmission-side facsimile apparatus 10a and the reception-side facsimile apparatus 10b.

The transmission-side facsimile apparatus 10a and the reception-side facsimile apparatus 10b perform communication (G3 communication) in accordance with a procedure specified in ITU-T Recommendation V.21, however, this is not limiting.

If data is transmitted from the transmission-side facsimile apparatus 10a to the reception-side facsimile apparatus 10b, first, dialing is performed from the transmission-side facsimile apparatus 10a to the reception-side facsimile apparatus 10b to establish communication connection, and thus, a calling tone (CNG) is transmitted.

In a case where the reception-side facsimile apparatus 10b is a device according to a procedure of the ITU-T Recommendation V.21, the reception-side facsimile apparatus 10b first transmits a called station identification signal (CED) if the reception-side facsimile apparatus 10b detects the calling tone from the transmission-side facsimile apparatus 10a.

Subsequently, the reception-side facsimile apparatus 10b notifies the transmission-side facsimile apparatus 10a of a function of the reception-side facsimile apparatus 10b by transmitting a non-standard facilities signal (NSF) including manufacturer information of the reception-side facsimile apparatus 10b, a called subscriber identification signal (CSI) including a telephone number of the reception-side facsimile apparatus 10b, and a digital transmit command signal (DIS) including performance information of the reception-side facsimile apparatus 10b such as a transmission speed and a maximum reception width.

Then, in response to these signals, the transmission-side facsimile apparatus 10a notifies the reception-side facsimile apparatus 10b of a function of the transmission-side facsimile apparatus 10a by transmitting a transmitting subscriber identification signal (TSI) including a telephone number of the transmission-side facsimile apparatus 10a, and a digital command signal (DCS) including performance information of the transmission-side facsimile apparatus 10a such as a transmission speed and a maximum reception width.

The transmission-side facsimile apparatus 10a may also notify the reception-side facsimile apparatus 10b of a non-standard procedure signal (non-standard facilities set-up: NSS) including manufacturer information of the transmission-side facsimile apparatus 10a.

Subsequently, if the reception-side facsimile apparatus 10b receives a training check signal (TCF) transmitted from the transmission-side facsimile apparatus 10a, a confirmation to receive signal (CFR) is transmitted as response from the reception-side facsimile apparatus 10b to the transmission-side facsimile apparatus 10a.

After receiving the CFR signal from the reception-side facsimile apparatus 10b, the transmission-side facsimile apparatus 10a transmits image data (PIX) for each page to the reception-side facsimile apparatus 10b.

If the transmission of all encoded data is completed, a procedure end signal (PPS-EOP) is transmitted to the reception-side facsimile apparatus 10b.

If the reception-side facsimile apparatus 10b confirms reception of the image data for all pages, a message confirmation signal (MCF) is transmitted as response from the reception-side facsimile apparatus 10b to the transmission-side facsimile apparatus 10a.

Finally, if a disconnect signal (DCN) is transmitted from the transmission-side facsimile apparatus 10a and received by the reception-side facsimile apparatus 10b, the facsimile communication ends.

The transmission and reception of such signals and data is controlled by the CPU 70 in both the transmission-side facsimile apparatus 10a and the reception-side facsimile apparatus 10b.

The above-described communication procedure is specified in the ITU-T Recommendation V.21, however, communication (Super G3 communication) may be also performed according to a procedure specified in ITU-T Recommendation V.8.

For example, the transmission-side facsimile apparatus 10a and the reception-side facsimile apparatus 10b are assumed to be compatible with Super G3.

In this case, if a CNG signal is transmitted from the transmission-side facsimile apparatus 10a to the reception-side facsimile apparatus 10b, the reception-side facsimile apparatus 10b transmits an ANSam signal, and the transmission-side facsimile apparatus 10a receives the ANSam signal, and thus, the V.8 procedure is started.

Accordingly, power supply information is transmitted thereafter.

Further, one of the transmission-side facsimile apparatus 10a and the reception-side facsimile apparatus 10b may be compatible with G3, and the other one of the transmission-side facsimile apparatus 10a and the reception-side facsimile apparatus 10b may be compatible with Super G3, and in this case, the former transmits a signal indicating that the former is compatible with V.21 to the latter to perform G3 communication.

In this case, after the former transmits the signal indicating that the former is compatible with V.21 and the G3 communication is started, a power failure signal is transmitted.

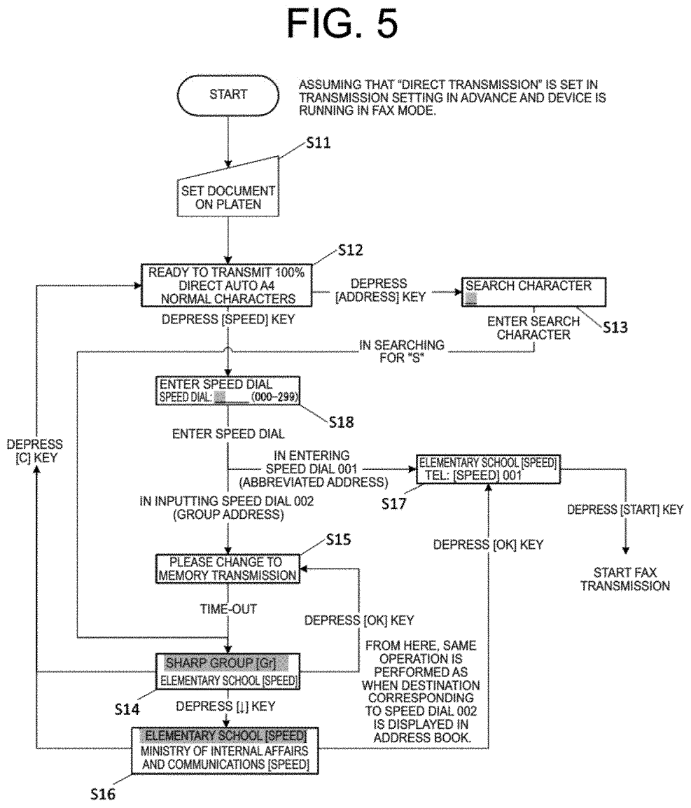

Subsequently, a flow of a screen transition process of the transmission-side facsimile apparatus 10a according to the first embodiment of the present invention will be described by using a flowchart in FIG. 5.

FIG. 5 is the flowchart illustrating an example of the screen transition process of the transmission-side facsimile apparatus 10a in FIG. 1.

It is assumed that a name and a fax number of a transmission destination are registered in a speed dial key on the operation panel 78.

In the first embodiment, it is assumed that a single destination with the name “elementary school”/search character “elementary school”/telephone number “01234567890” is registered in a speed dial 001

Further, it is assumed that a group destination with the name “Sharp Group”/search character “sharp group”/telephone numbers “09876543210 and 04321098765” is registered in a speed dial 002.

It is assumed that a single destination with the name “Ministry of Internal Affairs and Communications”/search character “Ministry of Internal Affairs and Communications”/telephone number “05555555555” is registered in a speed dial 003.

Further, it is assumed that the operation mode is set to a FAX mode by using a mode change key on the operation panel 78.

In step S11 of FIG. 5, the user sets a document to be transmitted to the destination on a platen on the scanner 55 of the transmission-side facsimile apparatus 10a (step S11).

Next, in step S12, the controller 50 controls the display panel 80 to display various types of settings used for facsimile transmission on the LCD of the display panel 80 (step S12).

In the example of FIG. 5, the display panel 80 displays, together with the message “ready to transmit”, a magnification of the read image (“100%” setting), a transmission setting (“direct” transmission setting in which the transmission-side facsimile apparatus 10a starts reading the document after connecting to the destination device, and communicates with the destination device while creating transmission data), a size detection setting (“auto” size detection setting), an actual transmission size (“A4” size setting), and a transmission resolution (“normal characters” setting corresponding to 8 pixels/mm×3.85 lines/mm).

Here, the user uses the keys on the operation panel 78 to instruct the transmission destination.

In typical facsimile apparatuses currently on the market, a dial number input by using the numeric keys, a speed dial number input by using a [speed] key, an address book search selected by using an [address] key, and the like can be utilized.

Here, a process in a case where the [address] key and the [speed] key are used is illustrated.

In step S12, if the user depresses the [address] key on the operation panel 78, the controller 50 controls the display panel 80 to display a search character input screen (step S13).

In step S13, if the user inputs “shi” in Katakana characters/“s” in English as a search character using the numeric keys, the controller 50 searches the address book data stored on the HDD 52, and the content of the group dial 002 with the search character “sharp group” is displayed in higher order (step S14).

In the example of FIG. 5, destinations with a search character that starts with “shi”/“s” in English are displayed in a list of descending order, and the cursor is located on “Sharp Group” at the top.

Next, if the user depresses the [OK] key on the operation panel 78, “Sharp Group” is selected. However, a group destination and direct transmission setting cannot be set simultaneously, and thus, in step S15, an error message for urging the user to change the transmission setting from the direct transmission to memory transmission is displayed (step S15).

Next, after a predetermined time period has elapsed, the controller 50 controls the display panel 80 to display the screen in step S14 (step S14).

As illustrated in step S14, in a display where the cursor is located at “Sharp Group”, the user can change the selection item by using a cursor key (arrow key) on the operation panel 78.

For example, the user can also depress the [⬇] (down arrow) key to select “elementary school” with the speed dial 001 and the search character “elementary school” as illustrated in step S16 (step S16).

Here, if the user depresses the [OK] key on the operation panel 78, “elementary school” is selected, and in step S17, the controller 50 controls the display panel 80 to display the content of the destination (step S17).

In the example of FIG. 5, the speed dial 001 and the name “elementary school” are displayed.

Here, if the user depresses the [start] key on the operation panel 78, the controller 50 starts facsimile transmission to “elementary school”.

On the other hand, in step S16, if the user depresses the [C] key instead of the [start] key, the controller 50 controls the display panel 80 to display the initial screen in step S12 (step S12).

If the user depresses the [C] key in step S14, the controller 50 controls the display panel 80 to display the initial screen in step S12 (step S12).

Next, a case where the user selects the speed dial in step S12 will be described.

If the user depresses the [speed] key on the operation panel 78 in step S12, the controller 50 controls the display panel 80 to display a speed dial input screen (step S18).

Here, the user inputs the speed dial of the transmission destination using the numeric keys.

In step S18, if the user inputs “001”, the speed dial 001 is selected, and in step S17, the controller 50 controls the display panel 80 to display the content of the speed dial 001 (step S17).

The subsequent operation is the same as that in the case where “elementary school” is selected in the address book selection.

On the other hand, if “002” is input in step S18, the speed dial 002 is selected. However, the group destination registered in the speed dial 002 and the direct transmission setting cannot be set simultaneously, and thus, in step S15, the controller 50 controls the display panel 80 to display an error message for urging the user to change the transmission setting to the memory transmission on the LCD of the display panel 80 (step S15).

Here, in the first embodiment, if the predetermined time period elapses, the controller 50 controls the display panel 80 to transition the screen displayed on the display panel 80 to the address book display in step S14 in which it is easy to determine the content of the destination being the error (step S14).

The subsequent operation is the same as that in the case where “Sharp Group” is displayed in the address book selection.

On the other hand, if the user depresses the [start] key in step S17, the controller 50 controls the scanner 55 to execute reading a document, and performs control to connect to the public network 30, and start FAX transmission to the reception-side facsimile apparatus 10b via the public network 30.

Afterwards, if the transmission process of the document image is completed, the controller 50 controls the display panel 80 to display disconnection of the line and the completion of the communication on the LCD of the display panel 80, and then the initial screen in step S12 (step S12), and a series of processes end (of which the description is omitted in FIG. 5).

Thus, if two transmission settings not settable at the same time are performed, after the display of an error message regarding a first transmission setting (in the first embodiment, the direct transmission setting), the controller 50 controls the display panel 80 to directly transition the screen to a screen (a setting screen for cancellation of the error) in which a setting change for a second transmission setting (in the first embodiment, the destination setting) can be performed, and thus, it is possible to achieve the facsimile apparatus 10 capable of easily identifying a cause of the error and resolving the error by a procedure easier than that in conventional devices.

### Second Embodiment

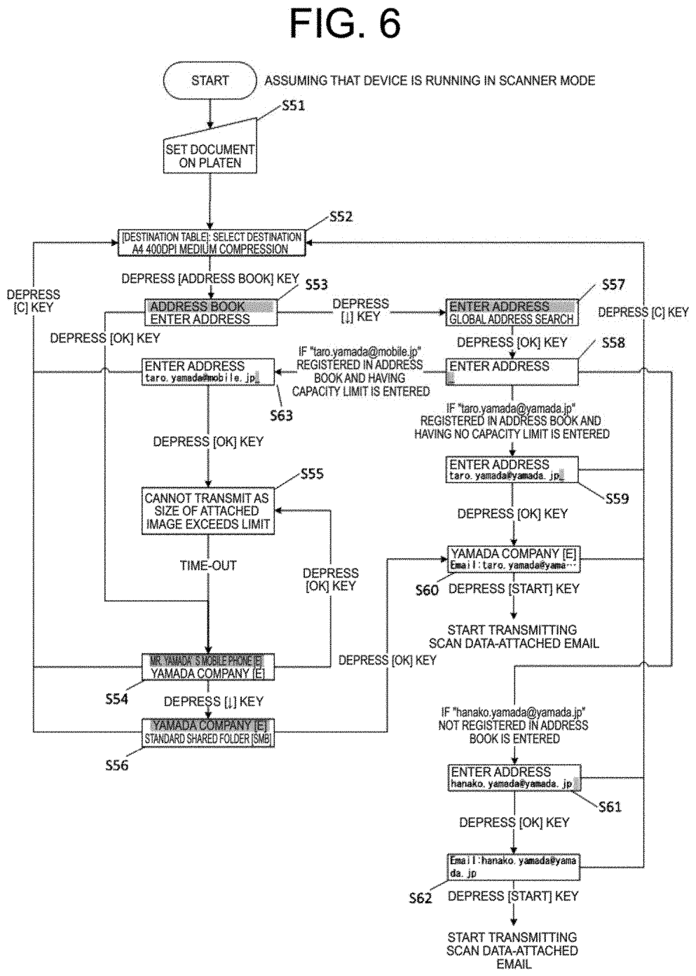

Next, a flow of a screen transition process of the transmission-side facsimile apparatus 10a according to a second embodiment of the present invention will be described by using a flowchart in FIG. 6.

FIG. 6 is the flowchart illustrating an example of a screen transition process of the transmission-side facsimile apparatus 10a according to the second embodiment of the present invention.

The configuration of the transmission-side facsimile apparatus 10a according to the second embodiment is similar to that in the first embodiment, and thus, description thereof is omitted.

In the second embodiment, it is assumed that a name and an email address of a transmission destination, and information whether there is a capacity limit of an attached image, are registered in an email transmission address book.

In the second embodiment, it is assumed that the name “Mr. Yamada's Mobile Phone”/search character “Mr. Yamada's Mobile Phone”/email address “taro.yamada@mobile.jp”/attached image capacity limit “Yes” is registered in a serial number 001, and the name “Yamada Company”/search character “Yamada Company”/email address “taro.yamada@yamada.jp”/attached image capacity limit “None” is registered in a serial number 002.

Further, it is assumed that the operation mode is set to a scanner mode by using the mode change key on the operation panel 78.

In step S51 of FIG. 6, the user sets a document to be attached to an email and transmitted to the destination, on a platen on the scanner 55 of the transmission-side facsimile apparatus 10a (step S51).

Next, in step S52, the controller 50 controls the display panel 80 to display various types of settings used for transmitting an email attached with an image on the LCD of the display panel 80 (step S52).

In the example of FIG. 6, size detection information (“A4” size detection), transmission resolution (“400 dpi” setting), and image data compression rate (“Medium compression” setting) are displayed in addition to the message “{Address table}: Select address”.

Next, if the user depresses the [address] key on the operation panel 78, in step S53, the controller 50 controls the display panel 80 to display a destination selection screen (step S53).

Here, the user uses the keys on the operation panel 78 to instruct the transmission destination.

In typical facsimile apparatuses currently on the market, an “address book” to select a destination from an address book registered in advance, an “address input” to directly input the email address of a destination, a “global address search” to acquire information from a server in the network, a “USB memory device” to acquire information from a USB memory device, and the like can usually be selected in the destination selection screen.

Here, an operation for a case where the “address book” key and the “address input” key are used is illustrated.

In step S53, if the user depresses the [OK] key on the operation panel 78 while the “address book” is highlighted, the controller 50 controls the display panel 80 to transition the screen to an address book screen (destination selection screen) (step S54).

The controller 50 searches the address book data stored on the HDD 52 and displays the address book data in a list.

In the example of FIG. 6, registered scanner transmission destinations are displayed in a list of descending order of search characters, and the cursor is located at “Mr. Yamada's Mobile Phone” with the serial number 001 having the search character “Mr. Yamada's Mobile Phone”.

Next, if the user depresses the [OK] key on the operation panel 78, “Mr. Yamada's Mobile Phone” is selected, however, if the image is read with a setting of A4 size, 400 dpi, and medium compression, the read image exceeds the capacity limit of the attached image, and thus, in step S55, an error message indicating that the read image cannot be transmitted with the current setting is displayed (step S55).

Afterwards, after a predetermined time period has elapsed, the controller 50 controls the display panel 80 to transition the screen to a screen of step S54 (step S54).

If the user depresses the [C] key in steps S54 and S56, the controller 50 controls the display panel 80 to display the initial screen in step S52 (step S52).

In the example of step S54, the cursor is located at “Mr. Yamada's Mobile Phone”, however, the user can use the cursor key (arrow key) on the operation panel 78 to change the selection item.

For example, the user can also depress the [⬇] (down arrow) key to select “Yamada Company” with the serial number 002 having the search character “Yamada Company”, as illustrated in step S56 (step S56).

Here, if the user depresses the [OK] key on the operation panel 78, “Yamada Company” is selected, and in step S60, the controller 50 controls the display panel 80 to display the content of the destination (step S60).

In the example of FIG. 6, the name “Yamada Company” and the registered email address are displayed.

Here, if the user depresses the [start] key on the operation panel 78, the controller 50 starts transmitting an email attached with scan data to “Yamada Company”.

On the other hand, if the user depresses the [C] key instead of the [start] key, the controller 50 controls the display panel 80 to display the initial screen in step S52 (step S52).

Next, a case where the user selects the address input in step S53 will be described.

In step S53, if the user depresses the [⬇] (down arrow) key on the operation panel 78 and depresses the [OK] key, the controller 50 controls the display panel 80 to transition the screen to an address input screen (destination selection screen) (step S58).

Here, the user inputs the email address of the transmission destination using the numeric keys.

In step S58, if the user inputs “taro.yamada@yamada.jp”, the input content coincides with the content of the serial number 002, and thus, in step S59, the controller 50 controls the display panel 80 to display the content of the serial number 002 (step S59).

The subsequent operation is the same as that in the case where “Yamada Company” is selected in the address book selection.

If the user inputs “taro.yamada@mobile.jp” in step S58, the input content coincides with the content of the serial number 001, and thus, in step S63, the controller 50 controls the display panel 80 to display the content of the serial number 001 (step S63).

Here, the serial number 001 is set with the attached image capacity limit “Yes”, and thus, if the user depresses the [OK] key, in step S55, the controller 50 controls the display panel 80 to display an error message indicating that the read image cannot be transmitted with the current setting on the LCD of the display panel 80 (step S55).

The subsequent operation is the same as that in the case where “Mr. Yamada's Mobile Phone” is displayed in the address book selection.

On the other hand, in step S58, if the user inputs “hanako.yamada@yamada.jp” and depresses the [OK] key (step S61), the address is not registered in the address book, and thus, the controller 50 determines whether the input content is an email address or an address of a storage folder in the network.

As a result, in step S62, the controller 50 controls the display panel 80 to display destination information added with an indication that the input content is an email address (step S62).

Here, if the user depresses the [start] key on the operation panel 78, the controller 50 starts transmitting an email attached with the scan data to “hanako.yamada@yamada.jp”.

On the other hand, if the user depresses the [C] key instead of the [start] key, the controller 50 controls the display panel 80 to display the initial screen in step S52 (step S52).

In step S60 and step S62, after the user depresses the [start] key, the controller 50 controls the scanner 55 to execute reading a document, and performs control to attach, to the email, the read data compressed by the image processor 56, and start transmitting the email to a mail server in the network 20 via the LAN I/F 66.

Afterwards, if the transmission process of the document image is completed, the controller 50 controls the display panel 80 to display the completion of the transmission process, and then display the initial screen in step S52 (step S52) on the LCD of the display panel 80, and a series of processes end (of which the description is omitted in FIG. 6).

Thus, if two transmission settings not settable at the same time due to a capacity limit of the attached image are performed, after displaying an error message regarding a first transmission setting (in the second embodiment, a capacity limit setting of the attached image), the controller 50 controls the display panel 80 to directly transition the screen to a screen (a setting screen for cancellation of the error) in which a setting change for a second transmission setting (in the second embodiment, the destination setting) can be performed, and thus, it is possible to achieve the facsimile apparatus 10 capable of easily identifying a cause of the error and resolving the error by a procedure easier than that in conventional devices.

### Third Embodiment

Next, the transmission-side facsimile apparatus 10a according to a third embodiment of the present invention will be described.

The configuration of the transmission-side facsimile apparatus 10a according to the third embodiment is similar to that in the first embodiment, and thus, description thereof is omitted.

As in the case where the user inputs the speed dial in the first embodiment, or as in the case where the user inputs an address such as “taro.yamada@mobile.jp” in the second embodiment, the input content which the user intends to set may include a combination of numbers, characters, and symbols from which the actual setting content cannot immediately be imagined.

In the third embodiment, if the input content in the transmission setting includes a combination of numbers, characters, and symbols from which the actual setting content cannot immediately be imagined, even if an error occurs after the input, the user does not easily image which type of error has occurred from the input content.

Therefore, the controller 50 determines, in accordance with a predetermined reference, whether the input content in the transmission setting includes a combination of numbers, characters, and symbols from which the actual setting content cannot immediately be imagined.

Specifically, if the input content set by the user includes, for example, a telephone number, a FAX number, an email address, an IP address, or a URL, the controller 50 determines that the input content includes a combination of numbers, characters, and symbols from which the actual setting content cannot immediately be imagined.

If the controller 50 determines that the input content corresponds to such a combination, the controller 50 controls the screen not to transition to a screen before the setting for the second transmission, but to transition directly to a screen (a setting screen for cancellation of the error) in which a setting change for the second transmission setting is possible.

On the other hand, if the controller 50 determines that the input content in transmission setting is an input content from which the actual setting content can immediately be imagined, such as input of an unregistered speed dial, no input of a destination, or a setting of an inappropriate sheet size, the controller 50 controls the screen to transition to a screen before the setting for transmission.

Thus, it is possible to achieve the facsimile apparatus 10 capable of directly transitioning to an address book display in which it is easy to determine the content of the destination being an error only if the user requires the transition.

Preferred aspects of the present invention include combinations of any aspects among the above-described plurality of aspects.

In addition to the above-described embodiments, various modifications in the present invention are possible. These modifications should not be interpreted as not belonging to the scope of the present invention. The present invention should include a meaning equivalent to the claims and all modifications within the scope.

### DESCRIPTION OF REFERENCE NUMERALS

1: Communication system,
10, 10a, 10b, 10c: Facsimile apparatus,
20: Network,
30: Public network,
50: Controller,
52: HDD,
54: Operation device,
55: Scanner,
56: Image processor,
57: Image memory,
58: Image former,
59: Transmission setting device,
60: Line controller,
62: Modem,
64: CI detector,
66: LAN I/F,
67: Power controller,
68: External power source,
70: CPU,
72: ROM,
74: RAM,
76: BUS line,
78: Operation panel,
80: Display panel

What is claimed is:

1. A communication apparatus, comprising:
an operation device that receives an operation of inputting information, designating a destination, and inputting a setting for transmission;
a transmitter that transmits information received via the operation device to a designated destination;
a transmission setting device that receives a setting for transmission via the operation device;
a display that displays a predetermined setting screen and a message; and
a controller that controls the operation device, the transmitter, the transmission setting device, and the display, wherein
if the transmission setting device has already received a setting for a first transmission, the controller determines, if a setting for a second transmission is received by the operation device, whether the setting for the second transmission is settable at the same time as the setting for the first transmission, and
if the controller determines that the setting for the second transmission is not settable at the same time as the setting for the first transmission, after controlling the display to display an occurrence of an error, the controller controls the display to display a setting screen related to a cancellation of the error, without returning to a screen before the occurrence of the error.

2. The communication apparatus according to claim 1, wherein the controller controls the display to display a setting screen corresponding to the setting for the second transmission as the setting screen for the cancellation of the error.

3. The communication apparatus according to claim 1, wherein the controller receives a cancellation setting of the error on the setting screen related to the cancellation of the error.

4. The communication apparatus according to claim 1, wherein, if determining that the setting for the second transmission is not settable at the same time as the setting for the first transmission, the controller determines, in accordance with a predetermined determination criterion, whether the setting for the second transmission allows a user to imagine a content of an error, and
if the controller determines that the setting for the second transmission does not allow the user to imagine the content of the error, after controlling the display to display an occurrence of the error, the controller controls the display to display a setting screen related to the cancellation of the error.

5. The communication apparatus according to claim 4, wherein, if a content input in the setting for the second transmission includes a telephone number, a facsimile number, an email address, an internet protocol address, or a Uniform Resource Locator, the controller determines that the setting for the second transmission does not allow a user to imagine a content of an error.

6. A method of controlling a communication apparatus, comprising:
inputting information and a setting for transmission and designating a destination;
receiving a setting for transmission in the inputting and the designating;
displaying a predetermined setting screen and a message; and
transmitting information input in the inputting and the designating to a designated destination, wherein
if a setting for a first transmission has already been received in the receiving, it is determined, if a setting for a second transmission is input in the inputting and the designating, whether the setting for the second transmission is settable at the same time as the setting for the first transmission, and
if it is determined that the setting for the second transmission is not settable at the same time as the setting for the first transmission, in the displaying, after displaying an occurrence of the error, a setting screen related to a cancellation of the error is displayed, without returning to a screen before the occurrence of the error.

7. A non-transitory computer-readable recording medium for recording a communication program causing a processor of a communication apparatus to execute:
inputting information and a setting for transmission and designating a destination;
receiving a setting for transmission in the inputting and the designating;
displaying a predetermined setting screen and a message; and
transmitting information input in the inputting and the designating to a designated destination, wherein
if a setting for a first transmission has already been received in the receiving, it is determined, if a setting for a second transmission is input in the inputting and the designating, whether the setting for the second transmission is settable at the same time as the setting for the first transmission, and
if it is determined that the setting for the second transmission is not settable at the same time as the setting for the first transmission, in the displaying, after displaying an occurrence of the error, a setting screen related to a cancellation of the error is displayed, without returning to a screen before the occurrence of the error.
